(19) United States
(12) Patent Application Publication
(10) Pub. No.: US 2008/0178112 A1
(43) Pub. Date: Jul. 24, 2008

(54) SYSTEM AND METHOD FOR RENDERING MULTIPLE USER INTERFACES

(76) Inventors: Robert B. Hruska, Seattle, WA (US); John K. Furukawa, Seattle, WA (US); Brent D. Newman, Sammamish, WA (US)

Correspondence Address: HOLLAND & KNIGHT LLP, 10 ST. JAMES AVENUE, BOSTON, MA, 02116, US

(21) Appl. No.: 11/624,977

(22) Filed: Jan. 19, 2007

(51) Int. Cl. G06F 3/048

(52) U.S. Cl. 715/778

(57) ABSTRACT

A method, computer program product, and multimodal user interface system for rendering a first graphical user interface on a display screen. The first graphical user interface includes a first functionality mapped to a first input option of a multi-option input device. The first functionality is configured to be enableable when the first graphical user interface is rendered. A second graphical user interface is rendered on the display screen. The second graphical user interface includes a second functionality mapped to the first input option of the multi-option input device. The second functionality is configured to be enableable when the second graphical user interface is rendered. The second graphical user interface is configured to at least partially obscure the first graphical user interface when rendered.

### TECHNICAL FIELD

This disclosure relates to user interfaces and, more particularly, to user interfaces for use on a client electronic device.

### BACKGROUND

Media distribution systems (e.g., the Rhapsody™ service offered by RealNetworks, Inc. of Seattle, Wash.) distribute media data files from a media server to a user's client electronic device (e.g., a personal media player, a personal digital assistant, or a multimedia cellular telephone). A media distribution system may distribute media data files by allowing a user to e.g., receive downloaded media data files and/or stream remote media data files.

Unfortunately, as client electronic devices are compact by design, they typically have small display screens, thus complicating the simultaneous presentation of multiple options for the user. Accordingly, the user may need to navigate multiple display screens using non-intuitive controls.

### SUMMARY OF DISCLOSURE

In a first implementation of this disclosure, a method includes rendering a first graphical user interface on a display screen. The first graphical user interface includes a first functionality mapped to a first input option of a multi-option input device. The first functionality is configured to be enableable when the first graphical user interface is rendered. A second graphical user interface is rendered on the display screen. The second graphical user interface includes a second functionality mapped to the first input option of the multi-option input device. The second functionality is configured to be enableable when the second graphical user interface is rendered. The second graphical user interface is configured to at least partially obscure the first graphical user interface when rendered.

One or more of the following features may be included. The multi-option input device may include one or more of a joystick, a keypad and a multi-position switch. The display screen and the multi-option input device may be included within a client electronic device. The multi-option input device may be configured to selectively enable the rendering of the first and second graphical user interfaces. At least one of the first and second graphical user interfaces may be configured to enable the rendering of a media data file. At least a third graphical user interface may be rendered on the display screen. The third graphical user interface may include a third functionality mapped to the first input option of the multi-option input device. The third functionality may be configured to be enableable when the third graphical user interface is rendered. The third graphical user interface may be configured to at least partially obscure the first and second graphical user interfaces when rendered.

In another implementation of this disclosure, a computer program product resides on a computer readable medium having a plurality of instructions stored on it. When executed by a processor, the instructions cause the processor to perform operations including rendering a first graphical user interface on a display screen. The first graphical user interface includes a first functionality mapped to a first input option of a multi-option input device. The first functionality is configured to be enableable when the first graphical user interface is rendered. A second graphical user interface is rendered on the display screen. The second graphical user interface includes a second functionality mapped to the first input option of the multi-option input device. The second functionality is configured to be enableable when the second graphical user interface is rendered. The second graphical user interface is configured to at least partially obscure the first graphical user interface when rendered.

One or more of the following features may be included. The multi-option input device may include one or more of a joystick, a keypad and a multi-position switch. The display screen and the multi-option input device may be included within a client electronic device. The multi-option input device may be configured to selectively enable the rendering of the first and second graphical user interfaces. At least one of the first and second graphical user interfaces may be configured to enable the rendering of a media data file. At least a third graphical user interface may be rendered on the display screen. The third graphical user interface may include a third functionality mapped to the first input option of the multi-option input device. The third functionality may be configured to be enableable when the third graphical user interface is rendered. The third graphical user interface may be configured to at least partially obscure the first and second graphical user interfaces when rendered.

In another implementation of this disclosure, a multimodal user interface system includes a display screen, and a multi-option input device configured to enable the selection of a plurality of input options. A first graphical user interface, renderable on the display screen, includes a first functionality mapped to a first input option of the multi-option input device. The first functionality is configured to be enableable when the first graphical user interface is rendered. A second graphical user interface, renderable on the display screen, includes a second functionality mapped to the first input option of the multi-option input device. The second functionality is configured to be enableable when the second graphical user interface is rendered. The second graphical user interface is configured to at least partially obscure the first graphical user interface when rendered.

One or more of the following features may be included. The multi-option input device may include one or more of a joystick, a keypad and a multi-position switch. The multi-modal user interface system may be included within a client electronic device. The multi-option input device may be configured to selectively enable the rendering of the first and second graphical user interfaces. At least one of the first and second graphical user interfaces may be configured to enable the rendering of a media data file. At least a third graphical user interface may be rendered on the display screen. The third graphical user interface may include a third functionality mapped to the first input option of the multi-option input device. The third functionality may be configured to be enableable when the third graphical user interface is rendered. The third graphical user interface may be configured to at least partially obscure the first and second graphical user interfaces when rendered.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a media distribution system and a client electronic device (executing a user interface process) coupled to a distributed computing network;

FIG. 2 is a diagrammatic view of the client electronic device of FIG. 1;

FIG. 3 is an isometric view of the client electronic device of FIG. 1 and a plurality of graphical user interfaces rendered by the user interface process of FIG. 1; and

FIG. 4 is a flowchart of the user interface process of FIG. 1.

### DETAILED DESCRIPTION OF EXEMPLARY EMBODIMENTS

### System Overview:

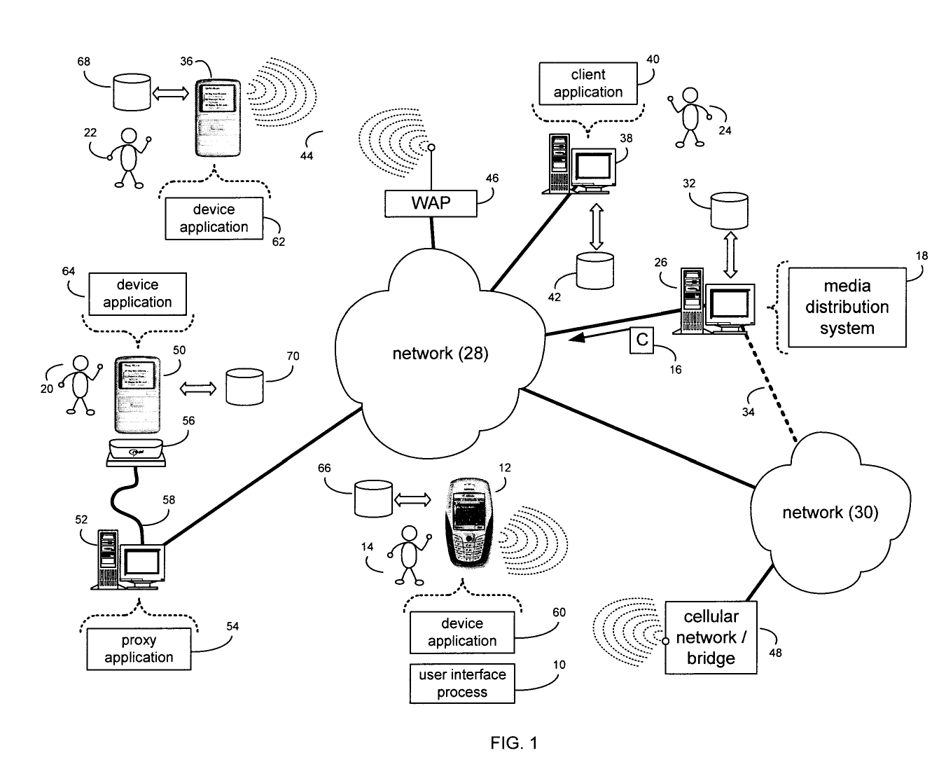

Referring to FIG. 1, there is shown a user interface process 10 that may be executable on a client electronic device (e.g., data-enabled cellular telephone 12) and may allow the user (e.g., user 14) of the client electronic device to navigate multiple graphical user interfaces (to be discussed below in greater detail).

The client electronic device may allow the user to obtain media content 16 from media distribution system 18. Media content 16 may be, for example, digitally-encoded audio and/or video media data files that may be compressed using known compression techniques. Examples of such compression techniques may include, but are not limited to, MPEG-1, MPEG-2, MPEG-4, H.263, H.264, Advanced Audio Coding, and such other techniques promulgated by the International Standards Organization (ISO) or Motion Picture Experts Group (MPEG).

Examples of the types of media content 16 received from media distribution system 18 may include but are not limited to: purchased downloads received from media distribution system 18 (i.e., media content licensed to e.g., user 14 for use in perpetuity); subscription downloads received from media distribution system 18 (i.e., media content licensed to e.g., user 14 for use while a valid subscription exists with media distribution system 18); and media content streamed from media distribution system 18, for example. Typically, when media content (e.g., media content 16) is streamed to e.g., a client electronic device, a copy of the media content is not permanently retained on the client electronic device. In addition to media distribution system 18, media content may be obtained from other sources, examples of which may include but are not limited to files ripped from music compact discs.

Examples of the media content 16 distributed by media distribution system 18 may include: audio media data files (examples of which may include but are not limited to music files, audio news broadcasts, audio sports broadcasts, and audio recordings of books, for example); video media data files (examples of which may include but are not limited to video footage that does not include sound, for example); audio/video media data files (examples of which may include but are not limited to a/v news broadcasts, a/v sports broadcasts, feature-length movies and movie clips, music videos, and episodes of television shows, for example); and multimedia content media data files (examples of which may include but are not limited to interactive presentations and slideshows, for example).

Media distribution system 18 may provide media data streams and/or media data files to a plurality of users (e.g., users 14, 20, 22, 24). Examples of such a media distribution system 18 may include, but are not limited to, the Rhapsody™ service offered by RealNetworks, Inc. of Seattle, Wash.

Media distribution system 18 may be a server application that resides on and is executed by computer 26 (e.g., a server computer, a plurality of server computers, or a general purpose computer) that is connected to network 28 (e.g., the Internet). Computer 26 may be a web server running a network operating system, examples of which may include but are not limited to Microsoft Windows XP Server™, Novell Netware™, or Redhat Linux™.

The instruction sets and subroutines of media distribution system 18, which may be stored on storage device 32 coupled to computer 26, may be executed by one or more processors (not shown) and one or more memory architectures (not shown) incorporated into computer 26. Additionally, the media data files available from media distribution system 18 may also be stored on e.g., storage device 32 attached to computer 26. Storage device 32 may include but is not limited to a hard disk drive, a tape drive, an optical drive, a RAID array, a random access memory (RAM), or a read-only memory (ROM).

Computer 26 may also execute a web server application, examples of which may include but are not limited to Microsoft IIS™, Novell Webserver™, or Apache Webserver™, that allows for HTTP (i.e., HyperText Transfer Protocol) access to computer 26 via network 28. Network 28 may be connected to one or more secondary networks (e.g., network 30), such as: a local area network; a wide area network; or an intranet, for example.

Users 14, 20, 22, 24 may access media distribution system 18 through e.g., network 28 and/or secondary network 30. Further, computer 26 (i.e., the computer that executes media distribution system 18) may be connected to network 28 through secondary network 30, as illustrated with phantom link line 34.

Media distribution system 18 may be accessed directly or may be accessed indirectly (e.g., through a proxy computer). For example, users 14, 22, 24 may directly access media distribution system 18 through various client electronic devices, examples of which may include, but are not limited to: data-enabled cellular telephone 12, personal media device 36; client computer 38, personal digital assistants (not shown); televisions (not shown); cable boxes (not shown); internet radios (not shown); and dedicated network devices (e.g., a Roku™ Soundbridge M500, M1000 and M2000; not shown), for example.

The devices directly accessing media distribution system 18 may be directly (e.g., physically) coupled to network 28 (or network 30). For example, client computer 38 is shown directly coupled to network 28 via a hardwired network connection.

Client computer 38 may execute a client application 40 (examples of which may include but are not limited to Microsoft Internet Explorer™ available from Microsoft Inc, of Redmond, Wash., Netscape Navigator™, Rhapsody™ client & RealPlayer™ client available from RealNetworks, Inc. of Seattle, Wash., or a specialized interface) that allows e.g., user 24 to access and configure media distribution system 18 via network 28 (or network 30). Client computer 38 may run an operating system, examples of which may include but are not limited to Microsoft Windows XP™, or Redhat Linux™.

The instruction sets and subroutines of client application 40, which may be stored on a storage device 42 coupled to client computer 38, may be executed by one or more processors (not shown) and one or more memory architectures (not shown) incorporated into client computer 38. Storage device 42 may include but is not limited to a hard disk drive, a tape drive, an optical drive, a RAID array, a random access memory (RAM), or a read-only memory (ROM).

Alternatively, the devices directly accessing media distribution system 18 may be indirectly (e.g., wirelessly) coupled to network 28 (or network 30). For example, personal media device 36 is shown wirelessly coupled to network 28 via a wireless communication channel 44 established between personal media device 36 and wireless access point (i.e., WAP) 46, which is shown directly coupled to network 28. WAP 46 may be, for example, an IEEE 802.11a, 802.11b, 802.11g, Wi-Fi, and/or Bluetooth device that is capable of establishing communication channel 44 between personal media device 36 and WAP 46.

As is known in the art, the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Additionally, data-enabled cellular telephone 12 is shown wirelessly coupled to network 30 via a cellular/network bridge 48 (which is shown directly coupled to network 30).

In addition to directly accessing media distribution system 18, client electronic devices may indirectly access media distribution system 18 through a proxy computer. For example, personal media device 50 is shown to access media distribution system 18 through proxy computer 52. Proxy computer 52 may execute proxy application 54, which may have functionality similar to that of client application 40.

Personal media device 50 may be connected to proxy computer 52 via a docking cradle 56. Personal media device 50 may include a bus interface (to be discussed below in greater detail) that couples personal media device 50 to docking cradle 56. Docking cradle 56 may be coupled (with cable 58) to e.g., a Universal Serial Bus (i.e., USB) port, a serial port, or an IEEE 1394 (i.e., FireWire) port included within proxy computer 52. For example, the bus interface included within personal media device 50 may be a USB interface, and docking cradle 56 may function as a USB hub (i.e., a plug-and-play interface that allows for “hot” coupling and uncoupling of personal media device 50 and docking cradle 56.

Proxy computer 52 may function as an Internet gateway for personal media device 50. For example, through the use of e.g., the universal plug and play protocol (i.e., UPnP), personal media device 50 may use proxy computer 52 to access media distribution system 18 via network 28 (and network 30) and obtain media content 16. Specifically, upon receiving a request for media distribution system 18 from personal media device 50, proxy computer 52 (acting as an Internet client on behalf of personal media device 50), may request the appropriate web page/service from computer 26 (i.e., the computer that executes media distribution system 18). When the requested web page/service is returned to proxy computer 52, proxy computer 52 may relate the returned web page/service to the original request (placed by personal media device 50 and may forward the web page/service to personal media device 50. Accordingly, proxy computer 52 may function as a conduit for coupling personal media device 50 to computer 26 and, therefore, media distribution system 18.

### Client Electronic Devices:

As discussed above, examples of client electronic devices may include, but are not limited to, data-enabled cellular telephone 12, personal media devices 36, 50, client computer 38, personal digital assistants (not shown), televisions (not shown); cable boxes (not shown); internet radios (not shown); and dedicated network devices (e.g., a Roku™ Soundbridge M500, M1000 and M2000; not shown), for example. Accordingly, while the following disclosure is directed towards data-enabled cellular telephone 12, it is understood that the following disclosure may be equally applied to any client electronic device (including personal media devices 36, 50, client computer 38, personal digital assistants (not shown), televisions (not shown); cable boxes (not shown); internet radios (not shown); and dedicated network devices (e.g., a Roku™ Soundbridge M500, M1000 and M2000; not shown), for example)).

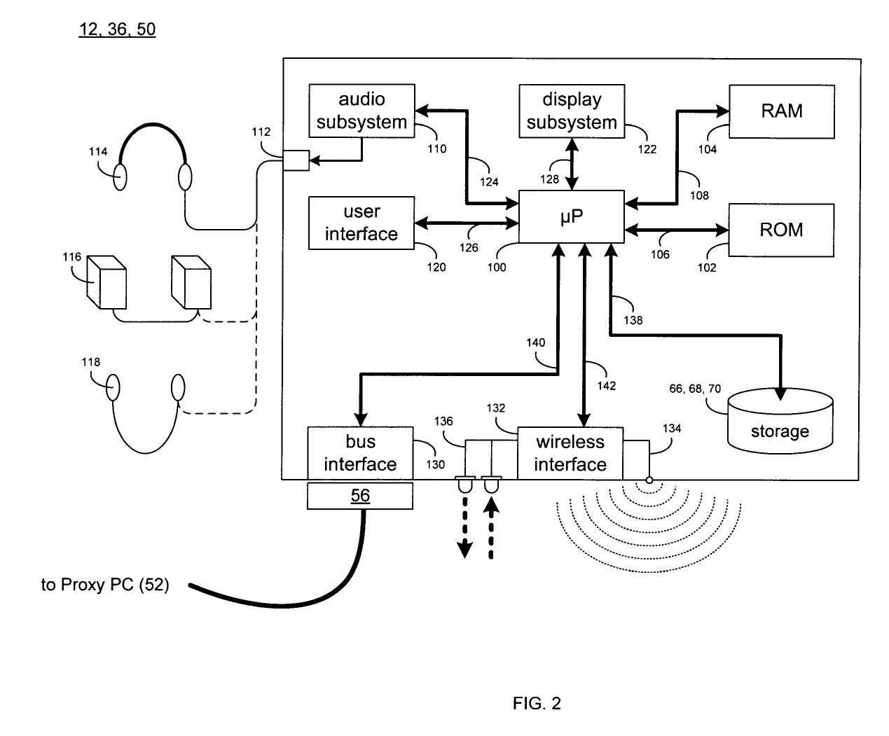

Referring also to FIG. 2, a general diagrammatic view of a client electronic device is shown. As discussed above, examples of client electronic devices may include, but are not limited to, data-enabled cellular telephone 12, personal media device 36, 50; client computer 38, personal digital assistants (not shown); televisions (not shown); cable boxes (not shown); internet radios (not shown); and dedicated network devices (e.g., a Roku™ Soundbridge M500, M1000 and M2000; not shown), for example.

Assume for illustrative purposes that FIG. 2 illustrates a portable client electronic device, such as data-enabled cellular telephone 12 and personal media device 36, 50. Data-enabled cellular telephone 12 and personal media device 36, 50 may include microprocessor 100 (e.g., an ARM™ microprocessor produced by Intel Corporation of Santa Clara, Calif.), non-volatile memory (e.g., read-only memory 102), and volatile memory (e.g., random access memory 104); each of which may be interconnected via one or more data/system buses 106, 108. Data-enabled cellular telephone 12 and personal media device 36, 50 may also include an audio subsystem 110 for providing e.g., an analog audio signal to an audio jack 112 for removable engaging e.g., a headphone assembly 114, a remote speaker assembly 116, or an ear bud assembly 118, for example. Alternatively, data-enabled cellular telephone 12 and personal media devices 36, 50 may be configured to include one or more internal audio speakers (not shown).

Data-enabled cellular telephone 12 and personal media device 36, 50 may each execute a device application 60, 62, 64 (respectively). Examples of device application 60, 62 64 may include but are not limited to Rhapsody™ client, RealPlayer™ client, or a specialized interface). Data-enabled cellular telephone 12 and personal media device 36, 50 may each execute an operating system, examples of which may include but are not limited to Microsoft Windows CE™, Microsoft Windows Mobile™, Redhat Linux™, Palm OS™, or a device-specific (i.e., custom) operating system.

The instruction sets and subroutines of device application 60, 62, 64, which may be stored on a storage device 66, 68, 70 (respectively) coupled to data-enabled cellular telephone 12 and personal media device 36, 50 (respectively), may be executed by one or more processors (not shown) and one or more memory architectures (not shown) incorporated into data-enabled cellular telephone 12 and personal media device 36, 50. Storage device 66, 68, 70 may be, for example, a hard disk drive, an optical drive, a random access memory (RAM), a read-only memory (ROM), a CF (i.e., compact flash) card, an SD (i.e., secure digital) card, a SmartMedia card, a Memory Stick, and a MultiMedia card, for example.

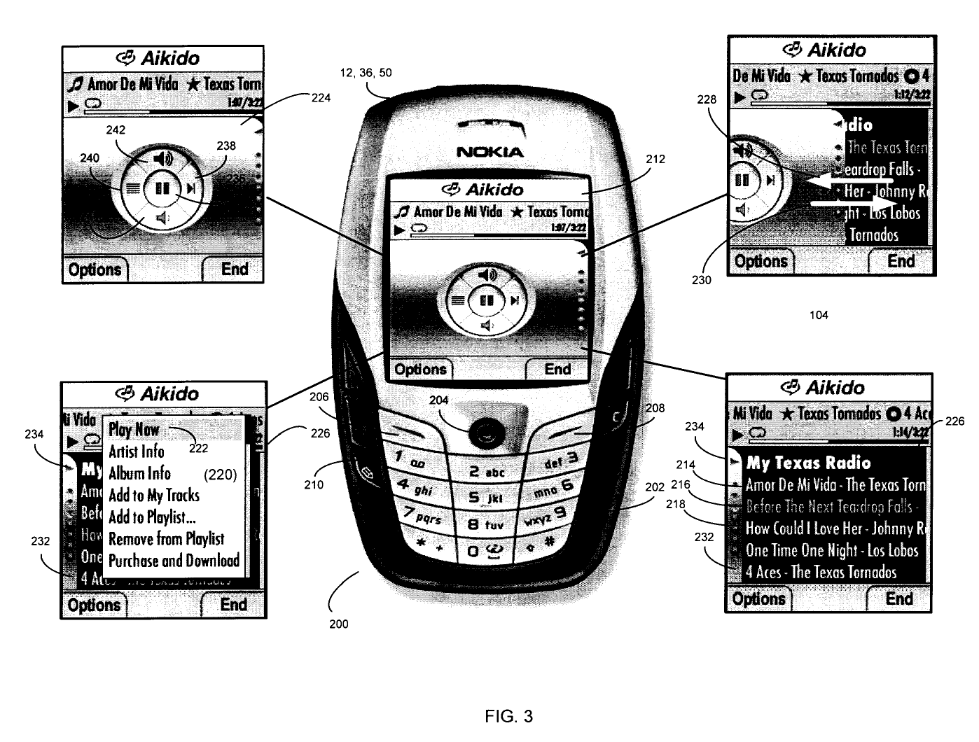

Data-enabled cellular telephone 12 and personal media device 36, 50 may also include a user interface 120 and a display subsystem 122. Referring also to FIG. 3, user interface 120 may receive data signals from a multi-option input device 200 included within data-enabled cellular telephone 12 and personal media device 36, 50, examples of which may include, but are not limited to, a keypad 202; multi-position switch (e.g., a joystick) 204; graphical user interface option switches 206, 208; and menu switch 210, for example. Display subsystem 122 may provide display signals to display panel 212 included within data-enabled cellular telephone 12 and personal media device 36, 50. Display panel 212 may be an active matrix liquid crystal display panel, a passive matrix liquid crystal display panel, or a light emitting diode display panel, for example.

Audio subsystem 110, user interface 120, and display subsystem 122 may each be coupled with microprocessor 100 via one or more data/system buses 124, 126, 128 (respectively).

During use of data-enabled cellular telephone 12 and personal media device 36, 50, display panel 212 may be configured to display various graphical user interfaces that may display various pieces of information such as e.g., the title and artist of various media data files 214, 216, 218 stored within data-enabled cellular telephone 12 and personal media device 36, 50.

Multi-option input device 200 may allow the user to scroll upward and/or downward through the list of media data files stored within data-enabled cellular telephone 12 and personal media device 36, 50. When the desired media data file is highlighted (e.g., “Before The Next Teardrop Falls” by “Freddy Fender”), the user may select the media data file for rendering using e.g., graphical user interface option switch 206.

Upon e.g., depressing graphical user interface option switch 206 when the desired media data file (e.g., “Before The Next Teardrop Falls” by “Freddy Fender”) is highlighted, an option menu 220 may be rendered that allows the user to select from a plurality of options. For example, the user may select the “play now” option 222 from menu 220 by e.g., depressing multi-position switch 204, thus resulting in the rendering of media data file 216 (e.g., “Before The Next Teardrop Falls” by “Freddy Fender”).

Using e.g., multi-position switch 204, the user may scroll downward to the next media data file (e.g., “How Could I Love Her” by “Johnny Rodriguez”) or may scroll upward to the previous media data file (e.g., “Amor De Mi Vida” by “Texas Tornadoes”). The use of multi-option input device 200 in conjunction with multiple graphical user interfaces will be discussed in more detail below.

Data-enabled cellular telephone 12 and personal media device 36, 50 may include a bus interface 130 for interfacing with e.g., proxy computer 52 via docking cradle 56. Additionally and as discussed above, data-enabled cellular telephone 12 and personal media device 36, 50 may be wirelessly coupled to network 28 (and/or other data-enabled cellular telephones/personal media devices) via e.g., a wireless communication channel 44 established between data-enabled cellular telephone 12/personal media device 36, 50 and e.g., WAP 46. Accordingly, data-enabled cellular telephone 12 and personal media device 36, 50 may include a wireless interface 132 for wirelessly-coupling data-enabled cellular telephone 12 and personal media device 36, 50 to network 28 (or network 30) and/or other data-enabled cellular telephones/personal media devices. Wireless interface 132 may be coupled to an antenna assembly 134 for RF communication to e.g., WAP 46, and/or an IR (i.e., infrared) communication assembly 136 for infrared communication with e.g., a second data-enabled cellular telephone/personal media device.

Further and as discussed above, data-enabled cellular telephone 12 and personal media device 36, 50 may include a storage device 66, 68, 70 (respectively) for storing the instruction sets and subroutines of device application 60, 62, 64 (respectively). Additionally, storage device 66, 68, 70 may be used to store media data files downloaded from media distribution system 18 and to temporarily store media data streams (or portions thereof) streamed from media distribution system 18.

Storage device 66, 68, 70, bus interface 130, and wireless interface 132 may each be coupled with microprocessor 100 via one or more data/system buses 138, 140, 142 (respectively).

As discussed above, media distribution system 18 may distribute media content 16 to e.g., users 14, 20, 22, 24, such that the media content distributed may be in the form of media data streams and/or media data files.

Accordingly, media distribution system 18 may be configured to only allow users to download media data files. For example, user 14 may be allowed to download, from media distribution system 18, media data files (i.e., examples of which may include but are not limited to audio files encoded and compressed using an MP3 encoder or an Advanced Audio Coding (AAC) encoder, or digital video encoded files), such that copies of the media data files are transferred to data-enabled cellular telephone 12.

Alternatively, media distribution system 18 may be configured to only allow users to receive and process media data streams of media data files. For example, user 20 may be allowed to receive and process (on personal media device 50) media data streams received from media distribution system 18. As discussed above, when media content is streamed from e.g., computer 26 to personal media device 50, a copy of the media data files may not be permanently retained on personal media device 50.

Further, media distribution system 18 may be configured to allow users to receive and process media data streams and download media data files. Examples of such a media distribution system may include the Rhapsody™ service offered by RealNetworks, Inc. of Seattle, Wash. Accordingly, user 22 may be allowed to download digital encoded media data files and receive and process media data streams from media distribution system 18. Therefore, copies of media data files may be transferred from computer 26 to personal media device 36; and streams of media data files may be received from computer 26 by personal media device 36.

### User Interface System:

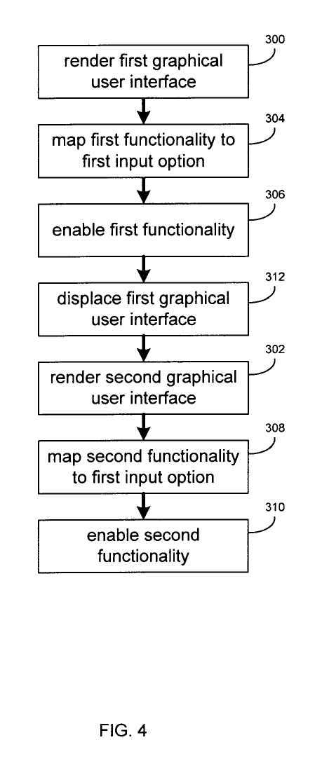

Referring also to FIG. 4 and as discussed above, client electronic devices (e.g., data-enabled cellular telephone 12, personal media devices 36, 50, client computer 38, personal digital assistants (not shown), televisions (not shown); cable boxes (not shown); internet radios (not shown); and dedicated network devices (e.g., a Roku™ Soundbridge M500, M1000 and M2000; not shown), for example) may execute user interface process 10 that allows the user to navigate a plurality of graphical user interfaces, each of which may allow the user to access various functionalities of the client electronic device. Examples of the various functionalities of the client electronic device may include, but are not limited to, internet access functionality, text messaging functionality, instant messaging functionality, telephone functionality, camera functionality, radio functionality, contact management functionality, MP3 player (i.e., media data file rendering) functionality, and access to media distribution systems 18.

The instruction sets and subroutines of user interface process 10, which may be stored on a storage device 66 coupled to data-enabled cellular telephone 12, may be executed by one or more processors (not shown) and one or more memory architectures (not shown) incorporated into data-enabled cellular telephone 12. Storage device 66 may be, for example, a hard disk drive, an optical drive, a random access memory (RAM), a read-only memory (ROM), a CF (i.e., compact flash) card, an SD (i.e., secure digital) card, a SmartMedia card, a Memory Stick, and a MultiMedia card, for example.

As each of the above-described unique functionalities may require unique controls, a custom graphical user interface may be desirable for each functionality. For example, when utilizing a client electronic device (e.g., data-enabled cellular telephone 12, and personal media devices 36, 50), to perform the functionality of an MP3 player, user interface process 10 may render 300 graphical user interface 224 (FIG. 3) on display panel 212 (FIG. 3) of data-enabled cellular telephone 12, and personal media devices 36, 50. However, when data-enabled cellular telephone 12, and personal media devices 36, 50 are used to browse a media distribution system (e.g. media distribution system 18), a second graphical user interface 226 may be rendered 302 (by user interface process 10) on display panel 212 of data-enabled cellular telephone 12, and personal media devices 36, 50. As the client electronic device may be capable of rendering multiple graphical user interfaces, user interface process 10 may be configured to allow the user to switch between the various user interfaces (e.g. graphical user interfaces 224, 226) rendered by user interface process 10.

Accordingly, user interface process 10 may be configured to allow a user (e.g. user 14, 20, 22) to switch between the various graphical user interfaces (e.g. graphical user interface 224, 226) by mapping one or more of the functionalities defined within each of a plurality of graphical user interfaces to a common multi-option input device 200. As discussed above, multi-option input device 200 may include one or more of a variety of input devices including but not limited to: numeric keypad 202; multi-position switch 204; graphical user interface option switches 206, 208; menu switch 210; slider switches (not shown); or any combination thereof.

When switching between graphical user interfaces 224, 226, user interface process 10 may be configured to allow one graphical user interface to be displaced with respect to the other graphical user interface (e.g. similar in the way that one window pane may slide from an open position to a closed position, thereby revealing another window pane disposed behind it.). For example, user interface process 10 may be configured to allow the user to “slide” graphical user interface 224 (in the direction of arrow 228) to allow for viewing of graphical user interface 226, which may be positioned behind graphical user interface 224. Further, user interface process 10 may be configured to allow the user to “slide” graphical user interface 224 (in the direction of arrow 230) to obscure viewing of graphical user interface 226, thus allowing for viewing of graphical user interface 224

As discussed above, multi-option input device 200 may include one or more of a variety of input devices including but not limited to: numeric keypad 202; multi-position switch 204; graphical user interface option switches 206, 208; menu switch 210; slider switches (not shown); or any combination thereof. Therefore, if only two graphical user interfaces are to be rendered (by user interface process 10) on display panel 212, a simple slider switch (not shown) may be used to enable one graphical user interface to be displaced with respect to the other. However, as a slider switch (not shown) may only allow for linear movement, if multi-directional movement is desired, other types of switches may be utilized. Accordingly, if a high number of graphical user interfaces are to be manipulated, a control that allows for movement in multiple directions, such as multi-position switch 204 and/or keypad 202 may be utilized, thus allowing for horizontal, vertical and/or diagonal displacement of the graphical user interfaces.

When a first graphical user interface (e.g. graphical user interface 224) is displaced to reveal a second graphical user interface (e.g. graphical user interface 226), the first graphical user interface may not completely disappear, but rather a portion 232 of the first graphical user interface may be visible. Visible portion 232 of the displaced graphical user interface (i.e., graphical user interface 224) may include textual or graphical instructions for sliding the displaced graphical user interface back into view. For example, visible portion 232 of graphical user interface 224 is shown to include a right-pointing arrow 234, thus indicating to the user that e.g., moving multi-position switch 204 to the right may make graphical user interface 224 “slide” to the right (in the direction of arrow 230) and obscure graphical user interface 226

When switching between graphical user interfaces 224, 226, user interface process 10 may be configured to allow multi-option input device 200 (e.g. numeric keypad 202, multi-position switch 204, graphical user interface option switches 206, 208; menu switch 210; slider switches (not shown); or any combination thereof) to provide the user with a variety of input commands corresponding to the functionality associated with the graphical user interface that is in use.

Thus, when user interface process 100 renders 300 first graphical user interface 224 on e.g., display screen 212, a first functionality (e.g., the “volume increase” functionality) may be mapped 304 to a first input option of a multi-option input device (e.g., the “up” position of multi-position switch 204). This first functionality may only be enabled 306 when first graphical user interface 224 is rendered 300. Further, when user interface process 100 renders 302 a second graphical user interface 226 on display screen 212, a second functionality (e.g., the “scroll up” functionality) may be mapped 308 to the same first input option of the multi-option input device (e.g., the “up” position of multi-position switch 204). This second functionality may only be enabled 310 when second graphical user interface 226 is rendered 302.

Accordingly, when using the client electronic device (e.g., data-enabled cellular telephone 12 and personal media devices 36, 50), user interface process 10 may render 300 graphical user interface 224 (e.g., a rendering menu) that allows the user to render media data files stored within the client electronic device. For illustrative purposes, graphical user interface 224 is shown to include five functionalities, namely: “pause/play” 236, “forward skip” 238, “library menu” 240, “volume increase” 242; and “volume decrease” 244. Each of these five functionalities may be mapped 304 to a unique input option of multi-option input device 200. For example, “pause/play” functionality 236 may be mapped 304 to “depressing” multi-position switch 204; “forward skip” functionality 238 may be mapped 304 to “moving to the right” multi-position switch 204; “library menu” functionality 240 may be mapped 304 to “moving to the left” multi-position switch 204; “volume increase” functionality 242 may be mapped 304 to “moving upward” multi-position switch 204; and “volume decrease” functionality 244 may be mapped 304 to “moving downward” multi-position switch 204. Each of these five functionalities may only be enabled 306 when graphical user interface 224 is rendered by user interface process 10.

Assume that the user wishes to browse the library of songs stored within the client electronic device. Accordingly, the user may select “library menu” functionality 240 by “moving to the left” multi-position switch 204. Once selected, graphical user interface 224 may be displaced 312 (along the direction of arrow 228) with respect to display screen 212. Specifically and in this embodiment, graphical user interface 224 “slides” to the left, and graphical user interface 226 (i.e., the graphical user interface positioned beneath graphical user interface 224) is rendered 302 by user interface process 10.

Graphical user interface 226 may allow the user to browse the library of media data files stored within the client electronic device. For illustrative purposes, graphical user interface 226 is shown to include four functionalities, namely: the “select a media data file” functionality which may be mapped 308 to “depressing” multi-position switch 204. The “rendering menu” functionality may be mapped 308 to “moving to the right” multi-position switch 204. The “scroll up” functionality may be mapped 308 to “moving upward” multi-position switch 204, and the “scroll down” functionality may be mapped 308 to “moving downward” multi-position switch 204. As with graphical user interface 224, each of these four functionalities may only be enabled 310 when graphical user interface 226 is rendered 302 by user interface process 10.

Assume that the user wishes to render “Before The Next Teardrop Falls” by “Freddy Fender”, the user may “scroll down” from media data file 214 to media data file 216 by “moving downward” multi-position switch 204. Once “Before The Next Teardrop Falls” by “Freddy Fender” is highlighted, the user may “select” “Before The Next Teardrop Falls” by “Freddy Fender” by “depressing” multi-position switch 204.

As discussed above, an option menu 220 may be rendered that allows the user to select from a plurality of options. For example, the user may select the “play now” option 222 from menu 220 by e.g., depressing multi-position switch 204, thus resulting in the rendering of media data file 216 (e.g., “Before The Next Teardrop Falls” by “Freddy Fender”). At this point, menu 220 may disappear, exposing graphical user interface 226. Assuming that the user wishes to view graphical user interface 224 (i.e., the rendering menu”), the user may select “rendering menu” functionality (of graphical user interface 226) by “moving to the right” multi-position switch 204. Once selected, graphical user interface 224 may be displaced 312 (along the direction of arrow 230) with respect to display screen 212. Specifically and in this embodiment, graphical user interface 224 “slides” to the right and obscures (at least partially) graphical user interface 226 (i.e., the library menu).

Once graphical user interface 224 is positioned in front of graphical user interface 226, “pause/play” functionality 236 may be mapped 304 to “depressing” multi-position switch 204; “forward skip” functionality 238 may be mapped 304 to “moving to the right” multi-position switch 204; “library menu” functionality 240 may be mapped 304 to “moving to the left” multi-position switch 204; “volume increase” functionality 242 may be mapped 304 to “moving upward” multi-position switch 204; and “volume decrease” functionality 244 may be mapped 304 to “moving downward” multi-position switch 204.

While a slider switch is described above in conjunction with two graphical user interfaces and a multi-position switch is described in conjunction with multiple graphical user interfaces, other configurations are possible. For example, multiple graphical user interfaces may be manipulated with a slider switch. In one possible implementation, pushing the up position on a slider switch may “slide” a first graphical user interface aside to reveal a second graphical user interface. Pushing the up position again may “slide” the second graphical user interface aside to reveal a third graphical user interface, and so on.

While a multi-position switch is described above in conjunction with navigating a graphical user interface, other configurations are possible. For example, data-enabled cellular telephone 12 and personal media devices 36, 50 may be configured to utilize keypad 202 for navigation of graphical user interfaces. In such an implementation, the “2” and “8” keys may be used to navigate up and down, the “4” and “7” keys may be used to navigate left and right, and the other numerical keys may similarly correspond to commands necessary to the functionality.

A number of implementations have been described. Nevertheless, it will be understood that various modifications may be made. Accordingly, other implementations are within the scope of the following claims.

What is claimed is:

1. A method comprising:
rendering a first graphical user interface on a display screen, the first graphical user interface including a first functionality mapped to a first input option of a multi-option input device, the first functionality configured to be enableable when the first graphical user interface is rendered; and
rendering a second graphical user interface on the display screen, the second graphical user interface including a second functionality mapped to the first input option of the multi-option input device, the second functionality configured to be enableable when the second graphical user interface is rendered, the second graphical user interface being configured to at least partially obscure the first graphical user interface when rendered.

2. The method of claim 1, wherein the multi-option input device includes one or more of a joystick, a keypad and a multi-position switch.

3. The method of claim 1, wherein the display screen and the multi-option input device are included within a client electronic device.

4. The method of claim 1, wherein the multi-option input device is configured to selectively enable the rendering of the first and second graphical user interfaces.

5. The method of claim 1, wherein at least one of the first and second graphical user interfaces is configured to enable the rendering of a media data file.

6. The method of claim 1 further comprising:
rendering at least a third graphical user interface on the display screen, the third graphical user interface including a third functionality mapped to the first input option of the multi-option input device, the third functionality configured to be enableable when the third graphical user interface is rendered, the third graphical user interface being configured to at least partially obscure the first and second graphical user interfaces when rendered.

7. A computer program product residing on a computer readable medium having a plurality of instructions stored thereon which, when executed by a processor, cause the processor to perform operations comprising:
rendering a first graphical user interface on a display screen, the first graphical user interface including a first functionality mapped to a first input option of a multi-option input device, the first functionality configured to be enableable when the first graphical user interface is rendered; and
rendering a second graphical user interface on the display screen, the second graphical user interface including a second functionality mapped to the first input option of the multi-option input device, the second functionality configured to be enableable when the second graphical user interface is rendered, the second graphical user interface being configured to at least partially obscure the first graphical user interface when rendered.

8. The computer program product of claim 7, wherein the multi-option input device includes one or more of a joystick, a keypad and a multi-position switch.

9. The computer program product of claim 7, wherein the display screen and the multi-option input device are included within a client electronic device.

10. The computer program product of claim 7, wherein the multi-option input device is configured to selectively enable the rendering of the first and second graphical user interfaces.

11. The computer program product of claim 7, wherein at least one of the first and second graphical user interfaces is configured to enable the rendering of a media data file.

12. The computer program product of claim 7 further comprising instructions for performing operations comprising:
rendering at least a third graphical user interface on the display screen, the third graphical user interface including a third functionality mapped to the first input option of the multi-option input device, the third functionality configured to be enableable when the third graphical user interface is rendered, the third graphical user interface being configured to at least partially obscure the first and second graphical user interfaces when rendered.

13. A multimodal user interface system comprising:
a display screen;
a multi-option input device configured to enable the selection of a plurality of input options;
a first graphical user interface, renderable on the display screen, the first graphical user interface including a first functionality mapped to a first input option of the multi-option input device, the first functionality configured to be enableable when the first graphical user interface is rendered; and
a second graphical user interface, renderable on the display screen, the second graphical user interface including a second functionality mapped to the first input option of the multi-option input device, the second functionality configured to be enableable when the second graphical user interface is rendered, the second graphical user interface being configured to at least partially obscure the first graphical user interface when rendered.

14. The multi-modal user interface system of claim 13, wherein the multi-option input device includes one or more of a joystick, a keypad and a multi-position switch.

15. The multi-modal user interface system of claim 13, wherein the multi-modal user interface system is included within a client electronic device.

16. The multi-modal user interface system of claim 13, wherein the multi-option input device is configured to selectively enable the rendering of the first and second graphical user interfaces.

17. The multi-modal user interface system of claim 13, wherein at least one of the first and second graphical user interfaces is configured to enable the rendering of a media data file.

18. The multi-modal user interface system of claim 13, further comprising:
at least a third graphical user interface, renderable on the display screen, the at least a third graphical user interface including a third functionality mapped to the first input option of the multi-option input device, the third functionality configured to be enableable when the at least a third graphical user interface is rendered, the at least a third graphical user interface being configured to at least partially obscure the first and second graphical user interfaces when rendered.
